(19) United States
(12) Patent Application Publication
(10) Pub. No.: US 2008/0252805 A1
(43) Pub. Date: Oct. 16, 2008

(54) Liquid crystal panel with anti-ESD conductive leads and liquid crystal display with same

(75) Inventors: Yi-Chang Lai, Miao-Li (TW); Tsung-Ping Liao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/082,768

(22) Filed: Apr. 14, 2008

(30) Foreign Application Priority Data
Apr. 13, 2007 (CN) 200710074013.3

(51) Int. Cl. G02F 1/133

(52) U.S. Cl. 349/40

(57) ABSTRACT

An exemplary liquid crystal panel includes a display region, and a bonding region adjacent to the display region. The bonding region includes a plurality of conductive terminals, a plurality of conductive fingers respectively provided generally opposite to the conductive terminals, and a plurality of substantially straight conductive leads respectively interconnecting the conductive terminals and the conductive fingers. A distribution of the conductive terminals is nonuniform. A first plurality of the plurality of conductive fingers have different widths from a second plurality of the plurality of conductive fingers. The conductive leads are substantially parallel to each other. A liquid crystal display employing the liquid crystal panel is also provided.

### FIELD OF THE INVENTION

The present invention relates to a liquid crystal panel resistant to damage from electrostatic discharge (ESD), and a liquid crystal display (LCD) employing the liquid crystal panel.

### GENERAL BACKGROUND

Recently, liquid crystal panels that are light and thin and have low power consumption characteristics have been widely used in office automation equipment, video units, and the like.

Referring to FIG. 4, a typical liquid crystal panel 10 includes a display region 100, and a bonding region 110 abutting the display region 100. A driving chip 120 is bonded on the bonding region 100.

Referring also to FIG. 5, the driving chip 120 includes a plurality of conductive terminals 122 provided at a long edge portion (not labeled) thereof, the long edge portion being farthest from the display region 100. The long edge portion of the driving chip 120 can be roughly divided in a central part, and two side parts at opposite sides of the central part respectively. A distribution of the conductive terminals 122 at the central part of the long edge portion is much denser than that at the two side parts of the long edge portion.

The bonding region 110 further includes a plurality of conductive fingers 113, and a plurality of straight conductive leads 114. The conductive fingers 113 have a same size, and a pitch between each two adjacent conductive fingers 113 is constant. The conductive leads 114 directly interconnect the conductive fingers 113 and the conductive terminals 122, respectively. The conductive leads 114 have a same line width.

Because the distribution of the conductive terminals 122 of the central part of the long edge portion of the driving chip 121 is much denser than that of the two side parts of the long edge portion, and the pitch between each two adjacent conductive fingers 113 is constant, the conductive leads 114 interconnecting the conductive fingers 113 and the conductive terminals 122 are inclined relative to each other and converge. That is, end portions (not labeled) of most of the conductive leads 114 are obliquely concentrated on areas (not labeled) adjacent to the central part of the long edge portion of the driving chip 121. This means electrostatic discharge is liable to occur between adjacent of these end portions. When electrostatic discharge takes place, some of the conductive leads 114 may be burned, and electrical performance of the liquid crystal panel 10 may be seriously impaired. The liquid crystal panel 10 may fail to work normally, or may operate unreliably.

What is needed, therefore, is a liquid crystal panel that can overcome the above-described deficiencies. What is also needed is a liquid crystal display employing the liquid crystal panel.

### SUMMARY

In an exemplary embodiment, a liquid crystal panel includes a display region, and a bonding region adjacent to the display region. The bonding region includes a plurality of conductive terminals, a plurality of conductive fingers respectively provided generally opposite to the conductive terminals, and a plurality of substantially straight conductive leads respectively interconnecting the conductive terminals and the conductive fingers. A distribution of the conductive terminals is nonuniform. A first plurality of the plurality of conductive fingers have different widths from a second plurality of the plurality of conductive fingers. The conductive leads are substantially parallel to each other.

Other aspects, novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is an exploded, side view of a liquid crystal display according to an exemplary embodiment of the present invention, the liquid crystal display including a liquid crystal panel.

FIG. 2 is a top plan view of the liquid crystal panel of FIG. 1.

FIG. 3 is an enlarged view of part of the liquid crystal panel of FIG. 2.

FIG. 4 is a top plan view of a conventional liquid crystal panel.

FIG. 5 is an enlarged view of part of the liquid crystal panel of FIG. 4.

### DETAILED DESCRIPTION OF PREFERRED EMBODIMENTS

Reference will now be made to the drawings to describe various embodiments of the present invention in detail.

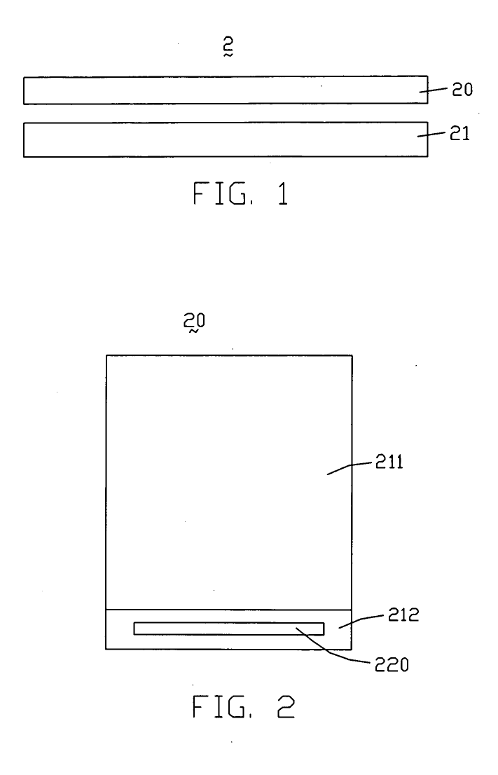

Referring to FIG. 1, a liquid crystal display 2 according to an exemplary embodiment of the present invention is shown. The liquid crystal display 2 includes a liquid crystal panel 20, and a backlight module 21 located adjacent to the liquid crystal panel 20. The backlight module 21 can provide planar light for the liquid crystal panel 20.

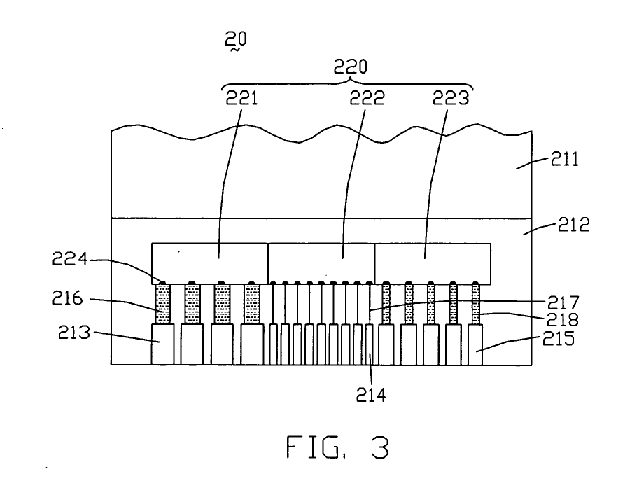

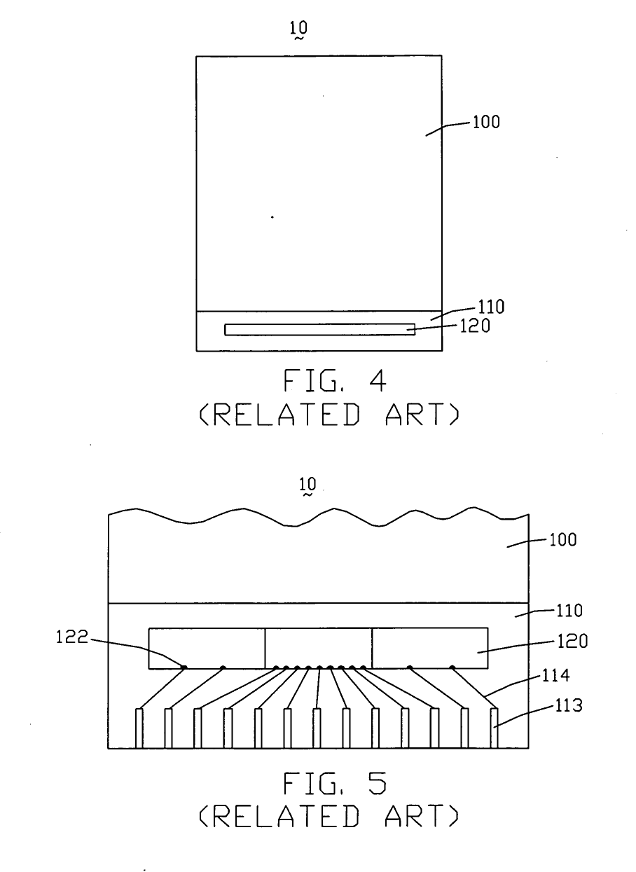

Referring also to FIG. 2, the liquid crystal panel 20 includes a display region 211, and a bonding region 212 adjacent to the display region 211. A driving chip 220 is bonded at the bonding region 212, for driving the liquid crystal panel 20.

Referring also to FIG. 3, the driving chip 220 is defined to include a first portion 221, a second portion 222, and a third portion 223, arranged in that order from left to right as shown. There is no gap between the first portion 221 and the second portion 222, and there is no gap between the second portion 222 and the third portion 223. Each of the first portion 221, the second portion 222, and the third portion 223 includes a plurality of conductive terminals 224 provided at a long edge (not labeled) thereof, the long edge portion being farthest from the display region 211. In the illustrated embodiment, a distribution of the conductive terminals 224 of the third portion 223 is denser than that of the conductive terminals 224 of the first portion 221, and is less dense than that of the conductive terminals 224 of the second portion 222.

The bonding region 212 further includes a plurality of first conductive fingers 213, a plurality of second conductive fingers 214, a plurality of third conductive fingers 215, a plurality of first straight conductive leads 216, a plurality of second straight conductive leads 217, and a plurality of third straight conductive leads 218. The first conductive fingers 213, the second conductive fingers 214, and the third conductive fingers 215 extend from an edge (not labeled) of the bonding region 212 farthest from the display region 211. The first conductive fingers 213, the second conductive fingers 214, and the third conductive fingers 215 respectively correspond to the conductive terminals 224 of the driving chip 220. A width of the third conductive fingers 215 is greater than that of the second conductive fingers 214, and less than that of the first conductive fingers 213. A pitch between each two adjacent first conductive fingers 213 is in the range from 0.3 μm to 0.4 μm. A pitch between each two adjacent second conductive fingers 214 is in the range from 0.1 μm to 0.2 μm. A pitch between each two adjacent third conductive fingers 215 is in the range from 0.2 μm to 0.3 μm. The first conductive leads 216 interconnect the conductive terminals 224 of the first portion 221 and the first conductive fingers 213. The second conductive leads 217 interconnect the conductive terminals 224 of the second portion 222 and the second conductive fingers 214. The third conductive leads 218 interconnect the conductive terminals 224 of the third portion 223 and the third conductive fingers 215. A line width of the first conductive leads 216 is less than but proportional to a line width of the first conductive fingers 213. A line width of the second conductive leads 217 is less than but proportional to a line width of the second conductive fingers 214. A line width of the third conductive leads 218 is less than but proportional to a line width of the third conductive fingers 215. That is, the line width of the third conductive leads 218 is greater than that of the second conductive leads 217, and less than that of the first conductive leads 216. The first conductive leads 216, the second conductive leads 217, and the third conductive leads 218 are substantially parallel to each other. In the illustrated embodiment, the first conductive fingers 213, the second conductive fingers 214, and the third conductive fingers 215 are rectangular, and are separate from each other.

In the liquid crystal panel 20, the first conductive leads 216 interconnecting the conductive terminals 224 of the first portion 221 and the first conductive fingers 213, the second conductive leads 217 interconnecting the conductive terminals 224 of the second portion 222 and the second conductive fingers 214, and the third conductive leads 218 interconnecting the conductive terminals 224 of the third portion 223 and the third conductive fingers 215, are substantially parallel to each other. That is, end portions (not labeled) of the first conductive leads 216, the second conductive leads 217, and the third conductive leads 218 are parallel to each other and do not converge. This helps to avoid the occurrence of electrostatic discharge between any two adjacent leads among the first, second and third conductive leads 216, 217, 218. Thus, the reliability of the liquid crystal panel 20 and the liquid crystal display 2 is improved. Further, the first, second, and third conductive leads 216, 217, 218 are straight, which makes the liquid crystal panel 20 easy to be fabricated, and a loss of energy transmission of the liquid crystal panel 20 is low.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal panel comprising:
a display region; and
a bonding region adjacent to the display region, the bonding region comprising:
a plurality of conductive terminals, a distribution of the conductive terminals being nonuniform;
a plurality of conductive fingers respectively provided generally opposite to the conductive terminals, a first plurality of the plurality of conductive fingers having different widths from a second plurality of the plurality of conductive fingers; and
a plurality of substantially straight conductive leads respectively interconnecting the conductive terminals and the conductive fingers, the conductive leads being substantially parallel to each other.

2. The liquid crystal panel as claimed in claim 1, further comprising a driving chip arranged at the bonding region, wherein the plurality of conductive terminals are arranged at an edge portion of the driving chip, the edge portion being farthest from the display region.

3. The liquid crystal panel as claimed in claim 2, wherein the distribution of the plurality of conductive terminals of a central edge portion of the driving chip is the densest.

4. The liquid crystal panel as claimed in claim 1, wherein a pitch between each two adjacent conductive fingers is in the range selected from the group consisting of 0.1 μm to 0.2 μm, 0.2 μm to 0.3 μm, and 0.3 μm to 0.4 μm.

5. The liquid crystal panel as claimed in claim 1, wherein a line width of one of the plurality of conductive leads corresponds to the width of the respective one of the plurality of conductive fingers connected thereto.

6. The liquid crystal panel as claimed in claim 5, wherein the line width of one of the plurality of conductive leads is less than but proportional to the width of the respective one of the plurality of conductive fingers connected thereto.

7. A liquid crystal panel comprising:
a display region; and
a bonding region adjacent to the display region, the bonding region comprising:
a plurality of conductive terminals, a distribution of the conductive terminals being nonuniform;
a plurality of conductive fingers respectively corresponding to the conductive terminals; and
a plurality of straight conductive leads respectively interconnecting the conductive terminals and the conductive fingers;
wherein a first plurality of the plurality of conductive leads have narrow line widths corresponding to a first plurality of the plurality of conductive terminals which are densely distributed, a second plurality of the plurality of conductive leads have wide line widths corresponding to a second plurality of the plurality of conductive terminals which are sparsely distributed, and widths of the conductive fingers are greater than but proportional to widths of the corresponding conductive leads.

8. The liquid crystal panel as claimed in claim 7, further comprising a driving chip arranged at the bonding region, wherein the plurality of conductive terminals are arranged at an edge portion of the driving chip, the edge portion being farthest from the display region.

9. The liquid crystal panel as claimed in claim 8, wherein the distribution of the plurality of conductive terminals of a central edge portion of the driving chip is the densest.

10. The liquid crystal panel as claimed in claim 7, wherein a pitch between each two adjacent conductive fingers is in the range selected from the group consisting of 0.1 μm to 0.2 μm, 0.2 μm to 0.3 μm, and 0.3 μm to 0.4 μm.

11. A liquid crystal display comprising:
a liquid crystal panel comprising:
a display region; and
a bonding region adjacent to the display region, the bonding region comprising:
a plurality of conductive terminals, a distribution of the conductive terminals being nonuniform;
a plurality of conductive fingers respectively provided generally opposite to the conductive terminals, a first plurality of the plurality of conductive fingers having different widths from a second plurality of the plurality of conductive fingers; and
a plurality of substantially straight conductive leads respectively interconnecting the conductive terminals and the conductive fingers, the conductive leads being substantially parallel to each other; and
a backlight module positioned for providing light beams for the liquid crystal panel.

12. The liquid crystal display as claimed in claim 11, further comprising a driving chip arranged at the bonding region, wherein the plurality of conductive terminals are arranged at an edge portion of the driving chip, the edge portion being farthest from the display region.

13. The liquid crystal display as claimed in claim 12, wherein the distribution of the plurality of conductive terminals of a central edge portion of the driving chip is the densest.

14. The liquid crystal display as claimed in claim 11, wherein a pitch between each two adjacent conductive fingers is in the range selected from the group consisting of 0.1 μm to 0.2 μm, 0.2 μm to 0.3 μm, and 0.3 μm to 0.4 μm.

15. The liquid crystal display as claimed in claim 11, wherein a line width of one of the plurality of conductive leads corresponds to the width of the respective one of the plurality of conductive fingers connected thereto.

16. The liquid crystal display as claimed in claim 15, wherein the line width of one of the plurality of conductive leads is less than but proportional to the width of the respective one of the plurality of conductive fingers connected thereto.
